(19) United States
(12) Patent Application Publication
(10) Pub. No.: US 2011/0210559 A1
(43) Pub. Date: Sep. 1, 2011

(54) ENERGY GENERATION SYSTEM WITH SELF OPENING AND CLOSING OF SAILS

(75) Inventors: Giancarlo Zanetti, Milano (IT); Gianfranco Ancona, Montignoso (IT)

(73) Assignee: ZANETTISTUDIOS S.R.L., Milano (IT)

(21) Appl. No.: 13/058,132

(22) PCT Filed: Aug. 7, 2009
(86) PCT No.: PCT/EP2009/060311

§ 371 Date: May 9, 2011

(30) Foreign Application Priority Data
Aug. 8, 2008 (EP) 08425554.6
Jan. 26, 2009 (EP) 09151327.5
Feb. 25, 2009 (EP) 09153560.9

(51) Int. Cl. F03D 9/00

(52) U.S. Cl. 290/55

(57) ABSTRACT

An embodiment for generating energy from a fluid flow is proposed. A corresponding energy generation system includes energy conversion means, sail means switchable between an active condition for being carried away from the energy conversion means by the fluid flow and a passive condition for minimizing said carrying away, connection means for connecting the sail means to the energy conversion means, the energy conversion means generating said energy when the sail means in the active condition is carried away, return means for returning the sail means in the passive condition towards the energy conversion means, and switching means for switching the sail means to the passive condition and to the active condition in response to a maximum distance and to a minimum distance thereof, respectively, from the energy conversion means. In an embodiment, the sail means includes a pair of sail modules slidable along the connection means, each sail module being individually switchable between the active condition and the passive condition; the switching means then includes stopping means for each sail module, the stopping means being adapted to stop the sliding of the corresponding sail module in the active condition when carried away thereby causing the switching thereof to the passive condition, passive locking means for each sail module, the passive locking means being adapted to lock the corresponding stopped sail module in the passive condition, coupling means for sliding each sail module locked in the passive condition in opposition to the fluid flow to a standing position along the connection means by the other sail module in the active condition when carried away, and active locking means for each sail module, the active locking means being adapted to lock the corresponding sail module in the standing position thereby causing the switching thereof to the active condition after the unlocking from the passive condition.

### PRIORITY CLAIM

The present application is a national phase application filed pursuant to 35 USC§371 of International Patent Application Serial No. PCT/EP2009/060311, filed Aug. 7, 2009; which further claims the benefit of European Patent Application Serial No. 08425554.6 filed Aug. 8, 2008; European Patent Application Serial No. 09151327.5 filed Jan. 26, 2009; and European Patent Application Serial No. 09153560.9 filed Feb. 25, 2009; all of the foregoing applications are incorporated herein by reference in their entireties.

### TECHNICAL FIELD

An embodiment generally relates to the field of the generation of energy. More specifically, an embodiment relates to the generation of energy from a fluid flow.

### BACKGROUND

Different types of energy generation systems (or simply generators) are known in the art for generating energy (for example, of the electrical type) through the transformation of another type of energy; with reference in particular to the generation of energy from renewable energy sources, generators that exploit a fluid flow (for example, the wind) have attained an increasing attention in the last years.

These (eolic) generators are commonly based on turbines (at horizontal axis), which are mounted atop vertical towers. Alternatively, generators based on parachutes have been proposed—for example, as described in U.S. Pat. No. 3,887,817, U.S. Pat. No. 4,124,182, U.S. Pat. No. 6,555,931, WO-A-2004/044418, and WO-A-2008/034421 (the entire disclosures of which are herein incorporated by reference).

Generally, these generators are based on a parachute (or a similar element) that may be switched between a closed condition and an open condition (in which it is carried away by the wind or the water); a balloon may also be associated with the parachute, so as to maintain it lifted. The parachute and the balloon are connected to an energy converter at ground through a connection cable. The parachute is alternatively opened and closed. When the parachute is open, it is carried away from the converter by the wind (so as to generate the desired electrical energy); the parachute is then closed, and returned towards the converter (by exploiting a small fraction of the generated electrical energy).

It is also possible to provide a pair of twin sections (each one including a parachute and a balloon), which are connected to each other by a single connection cable passing through an energy converter of the reciprocating type. In this case, the two parachutes are alternatively opened and closed. When a parachute is open, it is carried away from the converter by the wind (so as to generate the electrical energy); at the same time, it returns the other parachute towards the converter (without any waste of the generated electrical energy).

The above-described generators have a low environmental impact, and they may be installed practically everywhere; moreover, these generators are simple, reliable and easy to maintain (and then very cost effective). Notwithstanding, the generators based on the parachutes provides a very high yield. Indeed, in this case it is possible to exploit the wind at a relatively high height from the ground. As it is known, the speed of the wind generally increases moving away from the ground; for example, at 800 m above the ground the wind has an average speed of 6-10 m/s for 5,000-7,000 hours a year (against an average speed of 4-5 m/s for 2,000-4,000 hours a year at 80 m above the ground). Since the power of the wind (which is transformed into electrical energy by the converter) depends on the third power (cube) of its speed, it follows that any (even small) increase of the speed of the wind moving away from the ground involves a very high increase of its power.

However, a problem of the above-mentioned generators is the switching of the parachutes between their opening and the closing conditions. Indeed, these operations may require a relatively high energy, since at least one of them (for opening or closing the parachutes) has to be performed in opposition to the wind.

For this purpose, it is possible to add driving cables (extending from the converter to each parachute), which are used to drive the opening and the closing of the parachute from the ground. A drawback of the driving cables is their complexity (because of the need of transmitting a high force at a high distance); moreover, the driving cables are prone to malfunctioning—for example, because they may twist with the connection cable.

Alternatively, it is possible to mount a motor on board of each parachute. However, the motor typically must be relatively powerful, and then heavy (to provide the energy required to open and close the parachute). Therefore, the motor typically cannot be supplied with power locally neither by renewable energy generators—for example, solar panels (since they are typically unable to provide the required energy) nor by batteries (since their endurance is typically too low for practical applications). Conversely, if the motor is supplied remotely from the ground, a corresponding electrical cable extending from the converter to the parachute is required; this electrical cable may be dangerous—for example, in case of spikes or breaks thereof.

An additional problem of the generators based on two sections is the high risk of twist of the corresponding portions of the connection cable that extends from the converter (with a consequent stopping of their operation). When this happens, it may be necessary to lower the parachutes to ground for disentangle the portions of the connection cable. However, this operation may be very complex and time consuming; moreover, the twist of the portions of the connection cable may bring about damages to the generator.

### SUMMARY

In its general terms, an embodiment is based on the idea of exploiting the fluid flow itself for the switching.

An embodiment proposes an energy generation system for generating energy from a fluid flow. The system includes energy conversion means. The system further includes sail means, which is switchable between an active condition (for being carried away from the energy conversion means by the fluid flow) and a passive condition (for minimizing said carrying away). Connection means is provided for connecting the sail means to the energy conversion means; the energy conversion means generates said energy when the sail means in the active condition is carried away. Return means is instead used for returning the sail means in the passive condition towards the energy conversion means. The system then includes switching means for switching the sail means to the passive condition and to the active condition in response to a maximum distance and to a minimum distance thereof, respectively, from the energy conversion means. In an embodiment, the sail means includes a pair of sail modules that are slidable along the connection means; each sail module is individually switchable between the active condition and the passive condition. The switching means then includes stopping means for each sail module; the stopping means is adapted to stop the sliding of the corresponding sail module in the active condition when carried away, thereby causing the switching thereof to the passive condition. Passive locking means is also provided for each sail module; the passive locking means is adapted to lock the corresponding stopped sail module in the passive condition. The switching means further includes coupling means for sliding each sail module locked in the passive condition in opposition to the fluid flow to a standing position along the connection means by the other sail module in the active condition when carried away. Active locking means is also provided for each sail module; the active locking means is adapted to lock the corresponding sail module in the standing position, thereby causing the switching thereof to the active condition after the unlocking from the passive condition.

Another embodiment proposes a corresponding method.

A further embodiment proposes a computer program for performing a method.

A still further embodiment proposes a corresponding computer program product.

### BRIEF DESCRIPTION OF THE DRAWINGS

One or more embodiments, as well as features and the advantages thereof, will be best understood with reference to the following detailed description, given purely by way of a non-restrictive indication, to be read in conjunction with the accompanying drawings (wherein corresponding elements are denoted with equal or similar references and their explanation is not repeated for the sake of brevity). In this respect, it is expressly intended that the figures are not necessary drawn to scale (with some details that may be exaggerated and/or simplified) and that, unless otherwise indicated, they are merely used to conceptually illustrate the structures and procedures described herein. Particularly:

FIG. 1A-FIG. 1D illustrate operation of an energy generation system wherein an embodiment may be applied,

FIG. 2A-FIG. 2I illustrate an example of operation of an embodiment,

FIG. 3A-FIG. 3E shows an exemplary implementation of an embodiment,

FIG. 4 is a schematic representation of a particular of an energy generation system according to an embodiment,

FIG. 5A-FIG. 5D illustrate operation of another energy generation system wherein an embodiment may be used, and

FIG. 6A-FIG. 6D illustrate operation of an energy generation system according to an embodiment.

### DETAILED DESCRIPTION

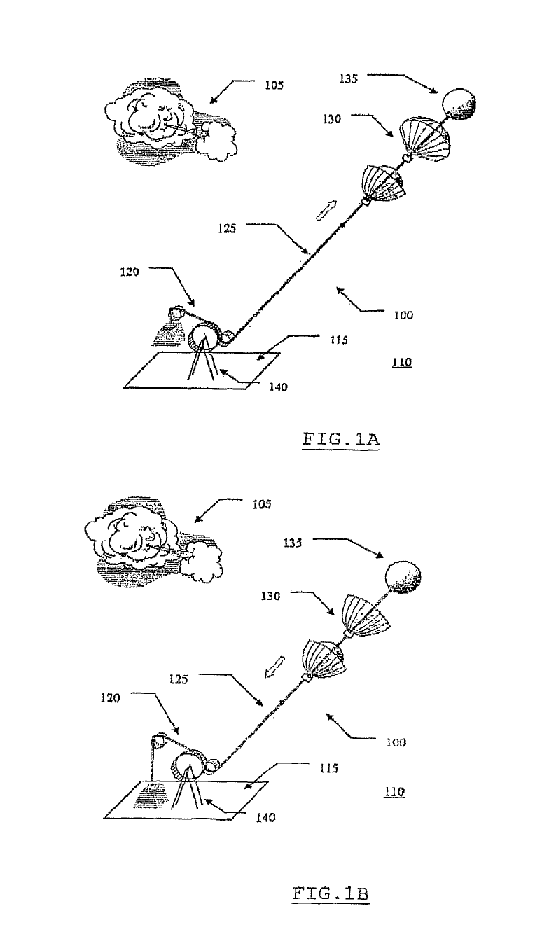

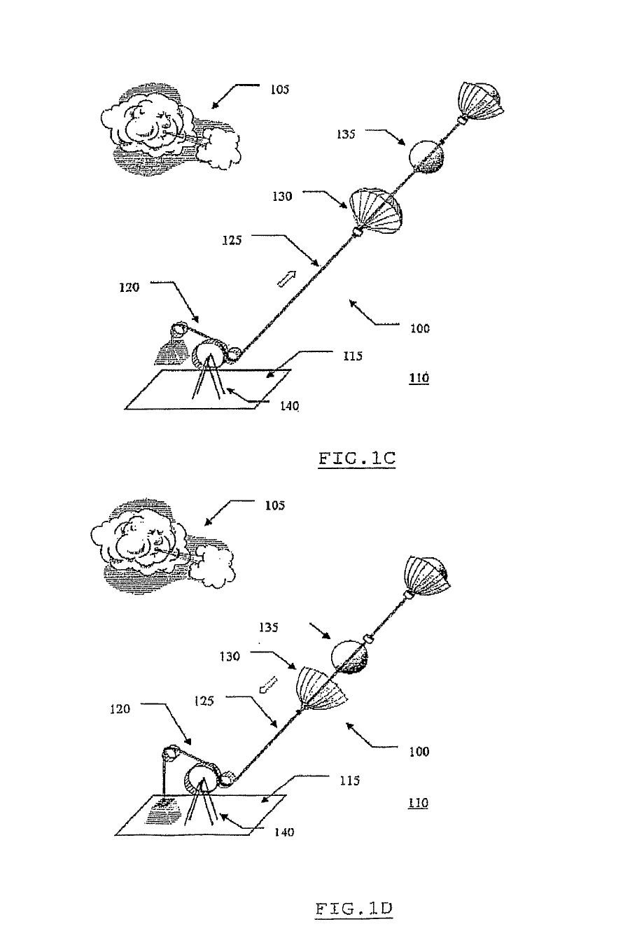

With reference in particular to FIG. 1A-FIG. 1D, there is illustrated operation of an energy generation system, or generator, 100 wherein an embodiment may be applied. The generator 100 is used to generate energy (for example, of the electrical type) from the wind; the wind (pictorially represented at the reference 105) consists of a flow of air, which is substantially parallel to ground 110 (from the left to the right in the figure).

For this purpose, the generator 100 includes a base 115, which is installed on the ground 110. An energy converter 120 is mounted on the base 115. A connection cable 125 connects a parachute complex 130 (including a pair of parachutes) to the power converter 120; the cable 120 has a length (for example, 1,000-1,200 m) allowing the parachute complex 130 to reach a desired height above the ground 110 (for example, 700-900 m), and it is dimensioned so as to sustain the applied forces (for example, being made of 12 twisted ropes in Dynema SK75, with thermic treatment and polyurethane coating). A balloon complex 135 (for example, including a pair of aerostatic balloons) is associated with the parachute complex 130, so as to maintain it lifted from the ground 110 even in the absence of the wind 105. A controller 140 is arranged in the base 115 for controlling operation of the whole generator 100; particularly, the controller 140 monitors an extension of the cable 125 from the converter 120, so as to measure a distance of the sail complex 130 from it. For example, the controller 140 is based on a microprocessor—with a control unit, a RAM being used as a working memory by the control unit, a flash E²PROM being used to store information to be preserved even when a power supply is off (particularly, a control program of the controller 140), a keypad, and a display.

In operation according to an embodiment, starting from FIG. 1A, when the parachute complex 130 is open (for example, with its upper parachute) the wind 105 carries the parachute complex 130 away from the converter 120 (towards the right in the example at issue). In this phase, the cable 125 is extracted from the converter 120 so as to accumulate energy (schematically represented with the lifting of a weight from the ground 110 in the figure); for example, the energy may be accumulated by unwinding the cable 125 from a rotor of an electrical generator (so as to apply a corresponding torque).

Considering now FIG. 1B, when the parachute complex 130 reaches a maximum distance from the converter 120 (for example, approximately 800-1,000 m) it is closed, so as to minimize its carrying away by the wind 105. The energy that was accumulated in the previous phase is now used by the converter 120 for returning the parachute complex 130 towards the converter 120 (schematically represented with the lowering of the weight to the ground 110 in the figure). However, the energy that is wasted for returning the parachute complex 130 towards the converter 120 is only a small fraction of the accumulated energy (since the drag that is opposed by the parachute complex 130 is now very low); therefore, a net result of the above-described two phases provides a surplus of energy that is used by the converter 120 to generate electrical energy.

Moving to FIG. 1C, when the parachute complex 130 reaches a minimum distance from the converter 120 it is open again (with its lower parachute now); for example, the minimum distance is equal to approximately 0.3-0.7, for example approximately 0.4-0.6, such as equal to approximately 0.5 times the maximum distance (for example, approximately 400-500 m). The same operations described above are then repeated. Particularly, the parachute complex 130 is carried away by the wind 105, and the cable 125 is extracted from the converter 120 so as to accumulate energy.

Likewise, as shown in FIG. 1D, when the parachute complex 130 reaches the maximum distance it is closed; the energy that was accumulated in the previous phase is again used by the converter 120 for returning the parachute complex 130 towards the converter 120 (in a small fraction) and for generating electrical energy. When the parachute complex 130 reaches the minimum distance again, it is open (with its upper parachute), so as to return the generator 100 to the situation shown in FIG. 1A (with the same operations described-above that are repeated continually).

This structure of the generator 100 (based on a single cable) is very simple and safe.

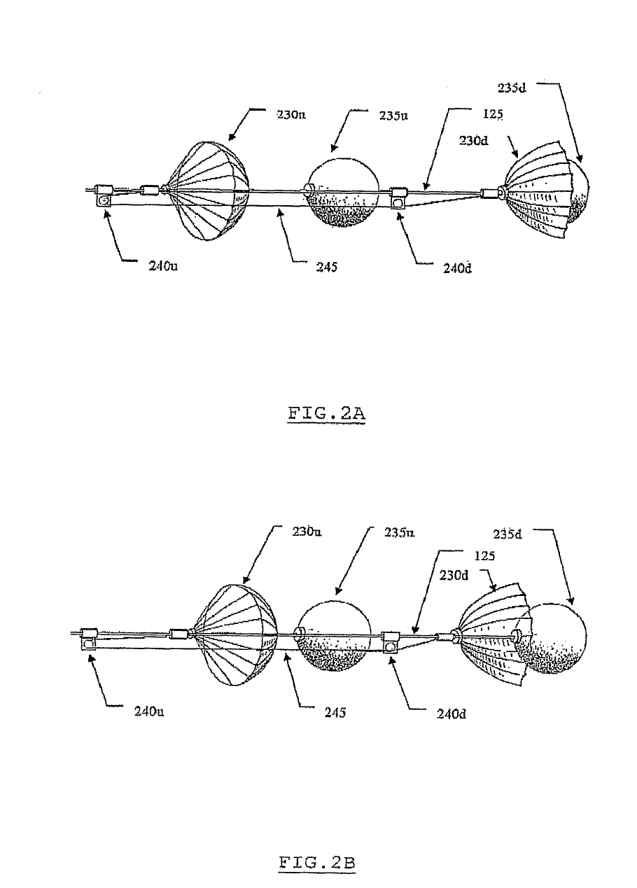

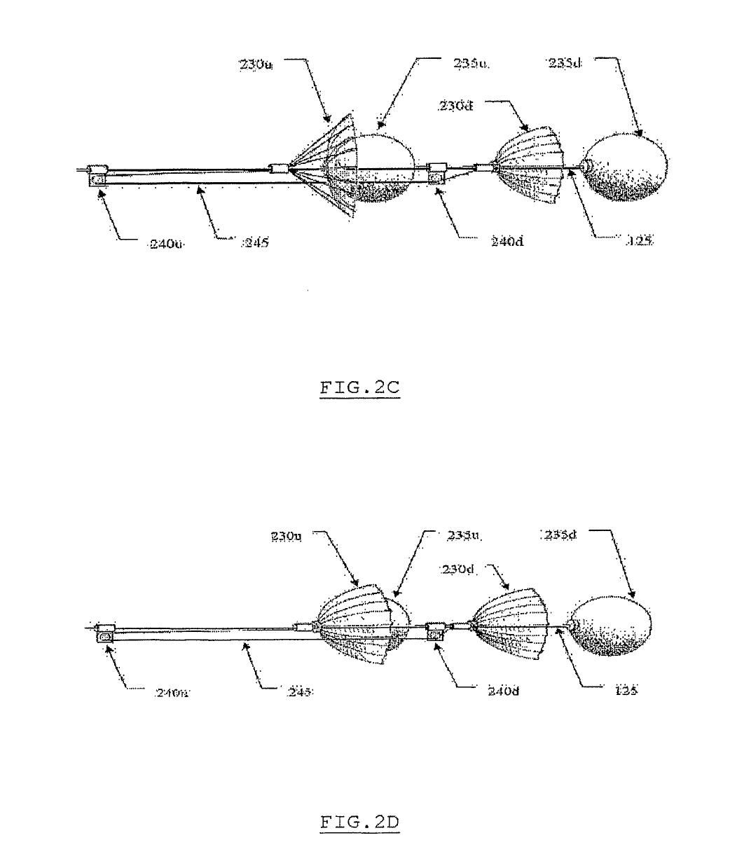

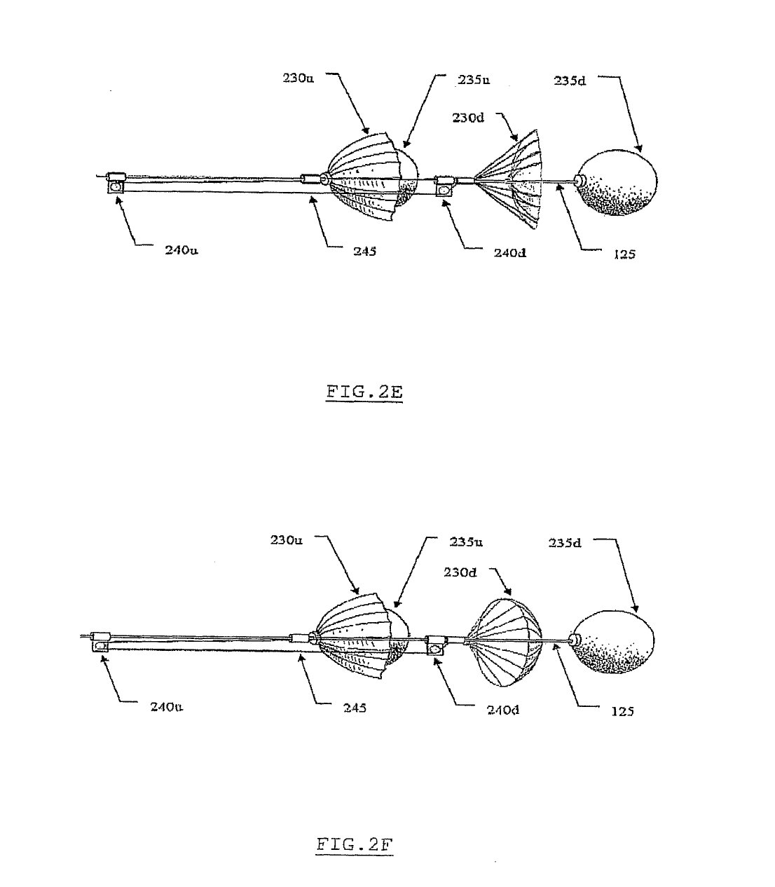

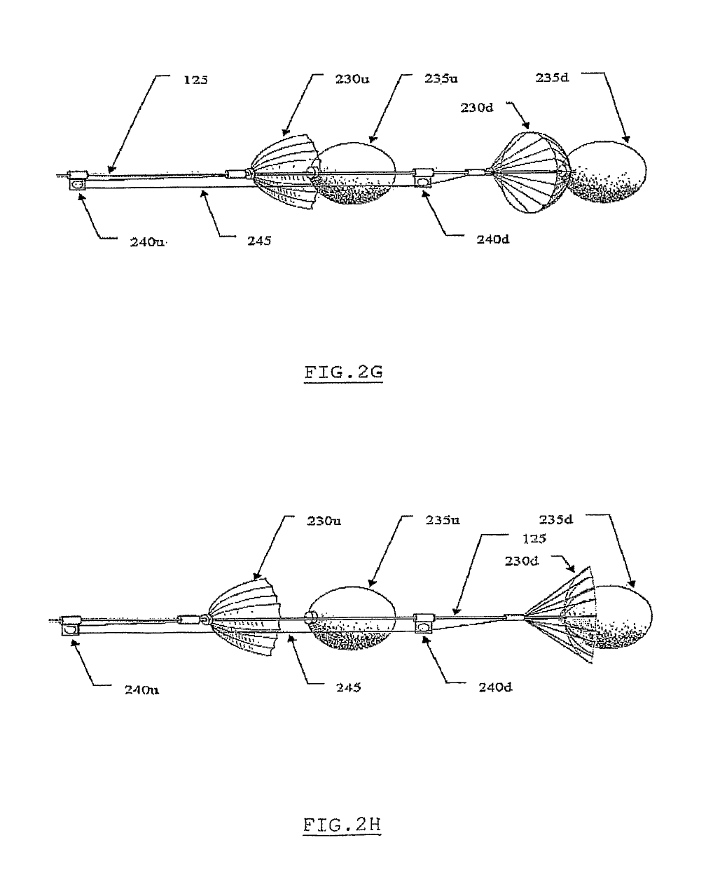

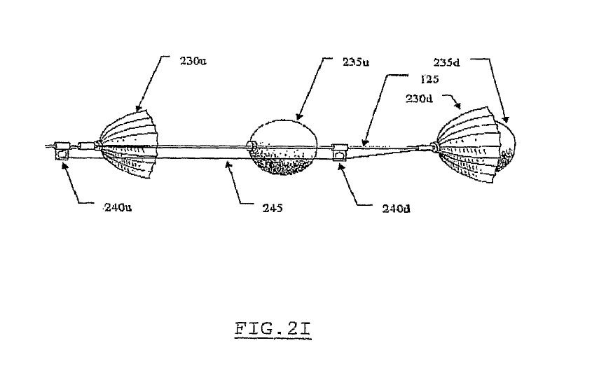

In an embodiment, the opening and closing of the parachute complex are performed by exploiting the wind itself. Particularly, an example of operation of an embodiment is illustrated in FIG. 2A-FIG. 2I.

For this purpose, the parachute complex is formed by a downstream parachute 230d and an upstream parachute 230u (with respect to the wind, flowing from the left to the right in the figure). Likewise, the balloon complex is formed by a downstream balloon 235d for the parachute 230d (fixed at a free end of the cable 125) and an upstream balloon 235u for the parachute 230u (fixed to the cable 125 between the balloon 235d and the converter, not shown to the left of the figure—for example, at 5-10 m from the balloon 235d); the parachute 230u is arranged upstream the balloon 235u, and the parachute 230d is arranged upstream the balloon 235d (downstream the balloon 235u). A latch 240u for the parachute 230u is arranged upstream the balloon 230u, and a latch 240d for the parachute 230d is arranged upstream the balloon 230d (downstream the balloon 235u)—for example, 5-10 m before the respective balloons 235u and 235d. The parachute 230u and the parachute 230d may slide along the cable 125 (between the latch 240u and the balloon 235u and between the latch 240d and the balloon 235d, respectively). A coupling mechanism 245 (including a cable with a pulley system) couples the parachutes 230u and 230d.

Starting from FIG. 2A, the parachute 230u is locked to the latch 240u, so as to prevent its sliding along the cable 125 and then maintain it open; the parachute 230d is instead locked in the closed condition around the balloon 235d. In this phase, the wind carries away the parachute 235u and then the cable 125 so as to accumulate energy.

Considering now FIG. 2B, the parachute 230u is unlocked from the latch 240u; the wind then makes the parachute 230u slide along the cable 125 (towards the right). At the same time, the parachute 230u pulls the parachute 230d in opposition to the wind through the coupling mechanism 245, so as to cause its sliding along the cable 125 in the opposite direction (towards the left).

As shown in FIG. 2C, when the parachute 230u reaches the balloon 235u, the parachute 230u overturns and folds around the balloon 235u so as to close.

Moving to FIG. 2D, the parachute 230u is then locked in the closed condition; at the same time, the parachute 230d reaches the latch 245d and it is locked thereto. In this phase, the cable 125 may be returned to the power converter, since both the parachutes 230u and 230d are closed.

With reference to FIG. 2E, the parachute 230d is unlocked from the closed condition (but remaining locked to the latch 240d); as a consequence, the wind overturns the parachute 230d.

Therefore, as shown in FIG. 2F, the parachute 230d opens, so as to return the generator to the same situation of FIG. 2A with the parachutes 230d and 230u in opposite conditions (i.e., the parachute 230d being open and the parachute 230u being closed); as above, the wind carries away the parachute 230d and then the cable 125 so as to accumulate energy.

The same operations are then repeated in a dual manner. Considering in particular FIG. 2G, the parachute 230d is unlocked from the latch 240d (so that the wind makes it slide along the cable 125). At the same time, the parachute 240d pulls the parachute 230u in opposition to the wind through the coupling mechanism 245, so as to cause its sliding along the cable 125 in the opposite direction.

As shown in FIG. 2H, when the parachute 230d reaches the balloon 235d, the parachute 230d overturns and folds around the balloon 235d so as to close.

Moving to FIG. 2I, the parachute 230d is then locked in the closed condition; at the same time, the parachute 230u reaches the latch 240u and it is locked thereto. In this phase, the cable 125 may again be returned to the power converter, since both the parachutes 230u and 230d are closed. The parachute 230u is then unlocked from the closed condition (but remaining locked to the latch 240u); as a consequence, the wind overturns and opens the parachute 230u so as to return the generator 100 to the situation shown in FIG. 2A (with the same operations described-above that are repeated continually).

An embodiment exploits the wind itself both to open each parachute (once it has been unlocked from the corresponding latch after being returned downstream by the other parachute) and to close it (against the corresponding balloon). Therefore, a desired result is achieved without any complex structure (for example, driving cables from the ground or motors on board of the parachutes).

This strongly simplifies the generator (with a corresponding reduction of its costs); the simplification of the generator also increases its reliability. Moreover, it may be possible to avoid the use of any risky component (such as electrical cables from the converter to the parachutes).

It is noted that the active actions that are now used to open and close the parachutes (for example, to unlock them from the corresponding latches or from the closed condition) only require a very low energy (since the actual operations of opening and closing the parachutes are instead performed by the wind). Therefore, the corresponding mechanisms that may be installed on board of the parachutes are very simple and light (so that they may be supplied locally—for example, by renewable energy generators or by batteries); moreover, this allows the use of very large parachutes, which may generate a high amount of energy per generator (for example, of the order of some hundreds of megawatts (MW) to some gigawatts (GW)).

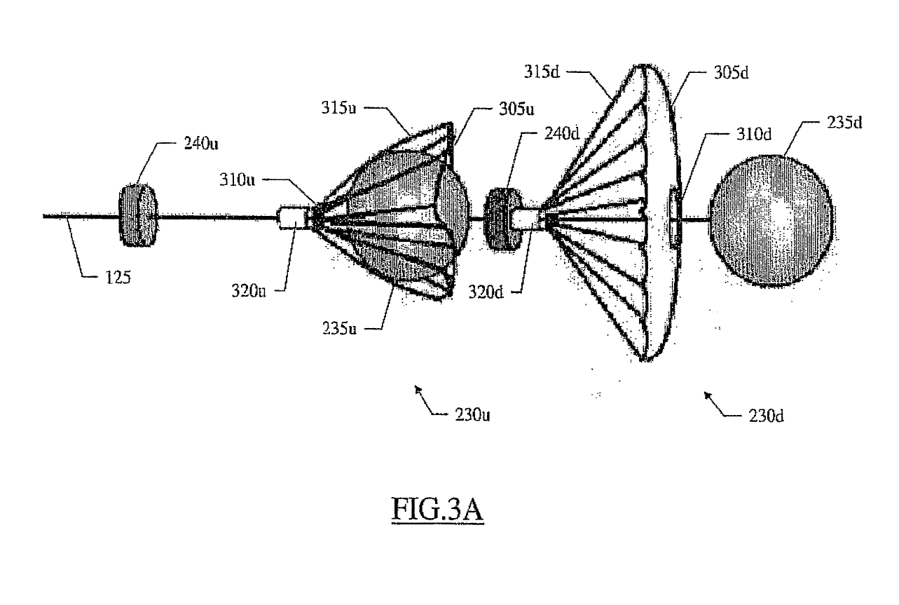

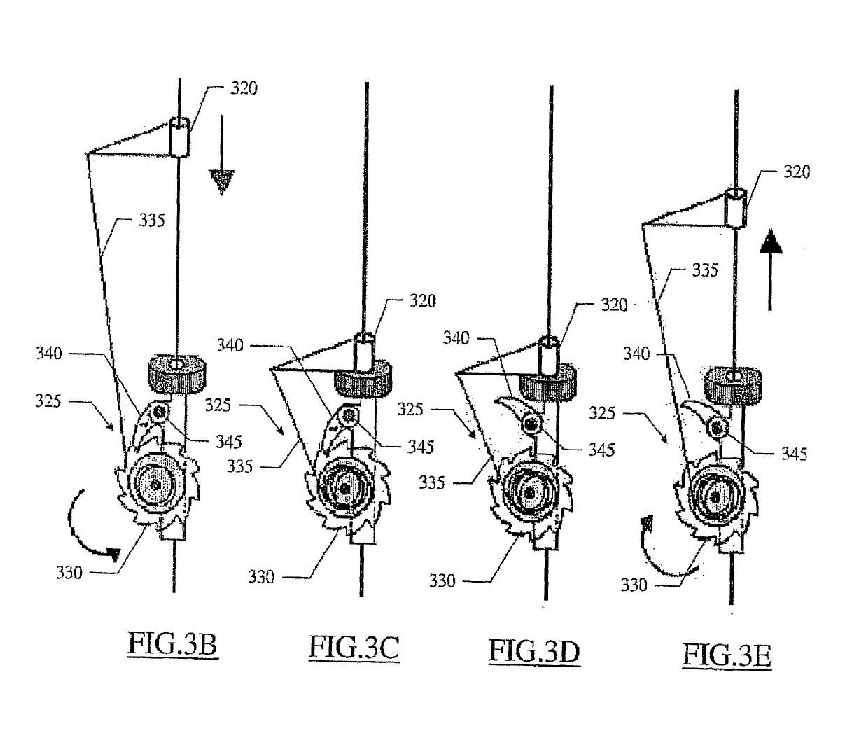

An exemplary embodiment is shown in FIG. 3A-FIG. 3E.

In detail (see FIG. 3A), each parachute 230d, 230u includes a sail 305d, 305u (for example, of the round type with a diameter of approximately 8-15 m for a balloon 235d, 235u with a diameter of approximately 5-8 m). The sail 305d, 305u is provided with an apical hole 310d, 310u, which allows its sliding along the cable 125. The apical hole 310d, 310u may be associated with a screw, which rotates the sail 310d, 305u when it slides along the cable 125 (clockwise or counter-clockwise); this increases the drag of the sail 310d, 305u when it is carried away by the wind (for example, by approximately 15-30%), with a corresponding increase of the yield of the generator.

Suspension lines 315d, 315u (for example, approximately 4-20) extend from a border of the sail 305d, 305u to a collector 320d, 320u (for example, a bush), which may slide along the cable 125 as well. The parachute 230d, 230u is locked to the latch 240d, 240u by locking the collector 320d, 320u thereto; the parachute 230d, 230u is instead locked in the closed condition by locking the collector 320d, 320u to the apical hole 310d, 310u. For this purpose, in an embodiment a ratchet is associated with the latch 240d, 240u and another ratchet is associated with the apical hole 310d, 310u.

In detail, as shown in FIG. 3B, a generic ratchet 325 (for either the latch or the apical hole) includes a gearwheel 330 that is fixed to the latch or the apical hole. A constraining cable 335 extends between the gearwheel 330 and the collector, generically denoted with the reference 320 (being provided with a spacer projecting laterally from the cable 125); the gearwheel 330 is spring biased so as to wind the cable 335 around it (counter-clockwise in the example at issue). The ratchet 325 also includes a pawl 340 (which is likewise fixed to the latch or to the apical hole); the pawl 340 is spring biased to engage the gearwheel 330, so as to prevent its rotation clockwise, and then the unwinding of the cable 335. A relay 345 disengages the pawl 340 from the gearwheel 330 in response to a remote unlocking command (received from the controller of the generator).

Moving to FIG. 3C, when the collector 320 moves towards the ratchet 325 (because the parachute is pulled towards the latch by the other parachute or because the sail is folded around the balloon by the wind), the cable 335 thus winds around the gearwheel 330 (which rotates counter-clockwise freely). However, after the collector 320 has reached the ratchet 325, the cable 335 may not unwind (since the pawl 340 prevents the rotation clockwise of the gearwheel 330), so that the collector 320 is maintained in this position (i.e., locked to the latch or in the closed condition).

With reference now to FIG. 3D, when the relay 345 receives the unlocking command, the pawl 340 disengages from the gearwheel 330.

In this condition, as shown in FIG. 3E, the gearwheel 330 is free to rotate counter-clockwise, so that the collector 320 may move away from the ratchet 325 by unwinding the cable 325 (because the parachute is carried away from the latch or because the sail is carried away from the collector by the wind).

The proposed implementation only uses a relay 345 to unlock the parachute from the latch (to cause its opening after reaching the balloon) or to unlock the parachute from the closed condition (to cause its opening). Therefore, the relay 345 may be supplied by a simple system that is installed on board of the parachute (for example, a battery, a photo-voltaic generator, or a small dedicated eolic generator). Moreover, the control of the ratchet only involves the sending of simple unlocking commands; therefore, these unlocking commands may be transmitted from the ground—for example, with a wireless connection (so as to avoid the addition of any auxiliary cable).

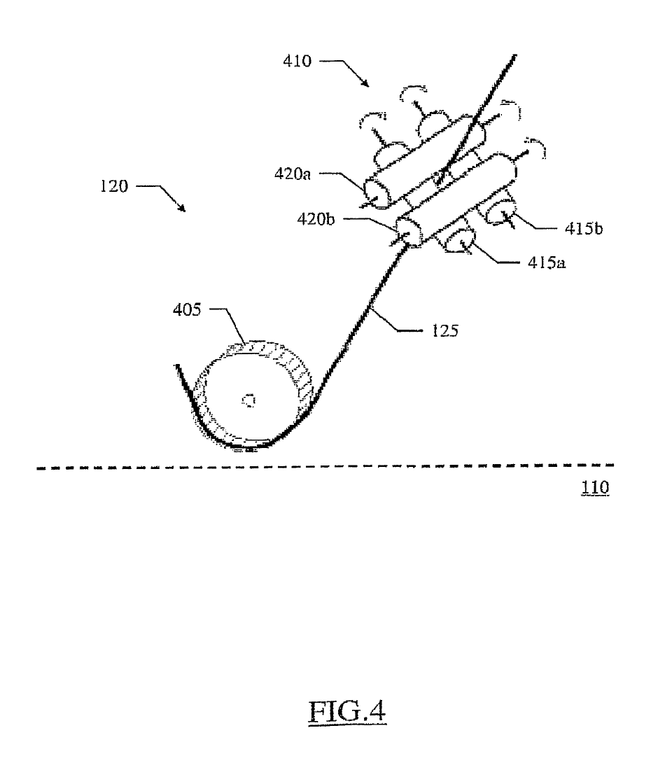

With reference now to FIG. 4, there is shown a schematic representation of a particular of the generator according to an embodiment.

In detail, the converter 120 includes a drum 405 for winding the cable 125. A guide 410 is used to maintain the cable 125 within the drum 405 with a correct slanting. For this purpose, the guide 410 includes a pair of idle rollers 415a, 415b and another pair of idle rollers 420a, 420b; the idle rollers of each pair 415a, 415b and 420a, 420b are parallel to each other (for example, at approximately 5-10 cm). The idle rollers 415a, 415b are arranged transversally to the idle rollers 420a, 420b; in this way, a passage for the cable 125 is formed between the idle rollers 415a, 415b and between the idle rollers 420a, 420b.

In this way, the cable 125 may slant with respect to the ground 110 in whatever direction; moreover, the idle rollers 415a, 415b, 420a and 420b avoid (or at least substantially reduce) any wear of the cable 125 (which would instead be caused by the friction thereof against a fixed guide).

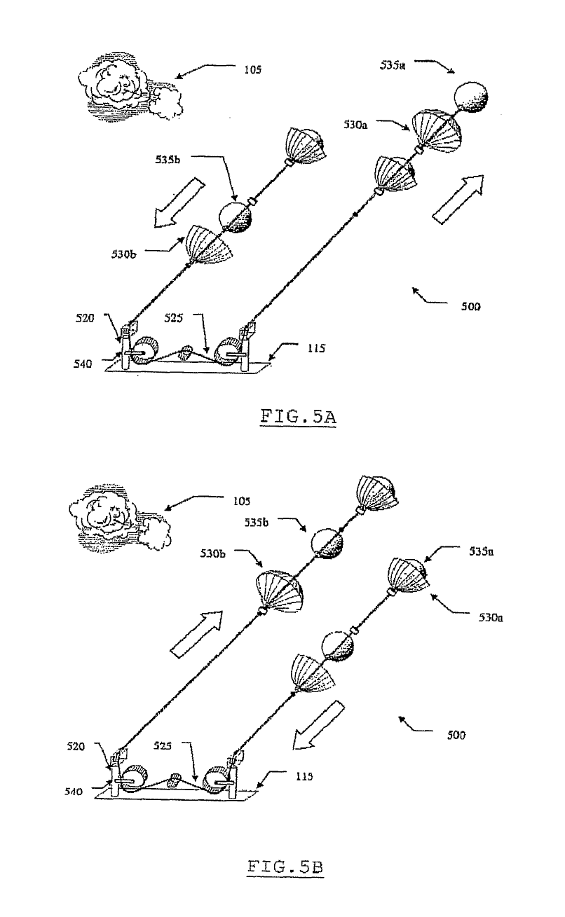

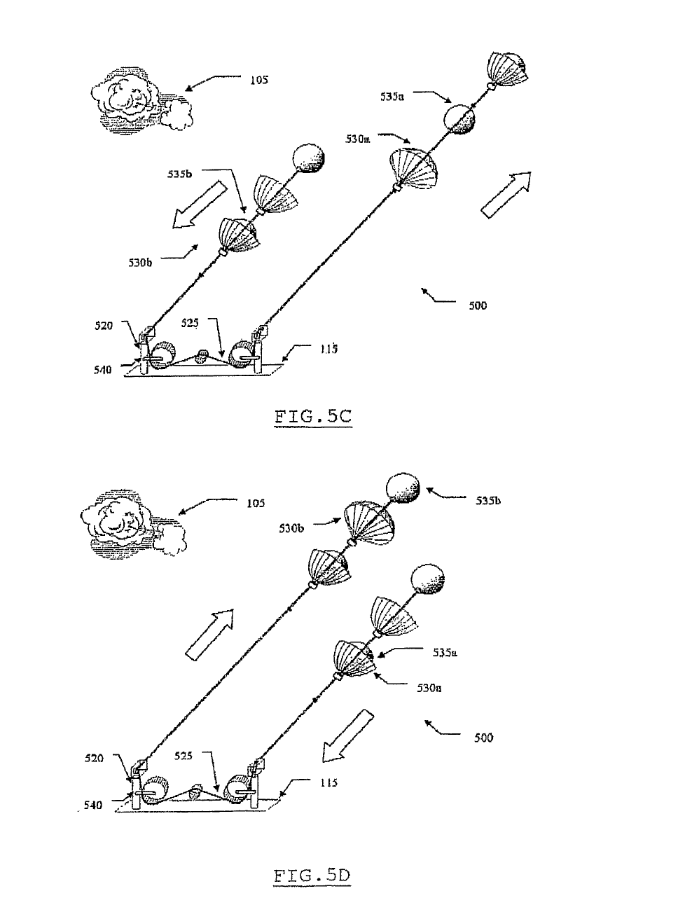

Moving to FIG. 5A-FIG. 5D, there is illustrated operation of another generator (denoted with the reference 500) wherein an embodiment may be used. Particularly, the generator 500 includes an energy converter 520 of the reciprocating type (mounted on the same base 115 but with a different controller 540); for example, the generator 520 includes a mechanism for converting the movement of a rotor in both directions into a unidirectional rotation that is used to generate electrical energy. In this case, the generator 500 includes two twin sections, each one being formed by a parachute complex 530a, 530b and a balloon complex 535a, 535b as above; in this case, however, a (single) cable 525 connects the parachute complex 530a and the parachute complex 530b to each other through the converter 520.

In operation, starting from FIG. 5A, when the parachute complex 530a is open (with its upper parachute) the wind 105 carries the parachute complex 530a away from the converter 520. In this phase, the cable 525 pulls the other parachute complex 530b that is closed towards the converter 520. However, as above the energy that is wasted for pulling the parachute complex 530b towards the converter 120 is only a small fraction of the energy that is produced by the parachute complex 530a being carried away by the wind; therefore, a net result of this phase provides a surplus of energy that is used by the converter 520 to generate electrical energy.

Considering now FIG. 5B, when the parachute complex 530a reaches the maximum distance it is closed; at the same time, the parachute complex 530b reaches the minimum distance, so that it is open (with its lower parachute). The two parachute complexes 530a and 530b then invert their function. Particularly, the wind 105 now carries the parachute complex 530b away from the converter 520, and the cable 525 pulls the parachute complex 530a towards the converter 520 (with the resulting surplus of energy that is again used by the converter 520 to generate electrical energy).

Moving to FIG. 5C, when the parachute complex 530b reaches the maximum distance and the parachute complex 530a reaches the minimum distance, the parachute complex 530b is closed and the parachute complex 530a is open again (with its lower parachute now). The same operations described above are then repeated. Particularly, the parachute complex 530a is carried away by the wind 105, and the cable 525 pulls the parachute complex 530b towards the converter 520 (with the resulting surplus of energy that is used by the converter 520 to generate electrical energy).

Likewise, as shown in FIG. 5D, when the parachute complex 530a reaches the maximum distance and the parachute complex 530b reaches the minimum distance, the parachute complex 530a is closed and the parachute complex 530b is open again (with its upper parachute now); therefore, the parachute complex 530b is carried away by the wind 105, and the cable 525 pulls the other parachute complex 530a towards the converter 520 (with the resulting surplus of energy that is used by the converter 520 to generate electrical energy). When the parachute complex 530b reaches the maximum distance and the parachute complex 530a reaches the minimum distance, the parachute complex 530b is closed and the parachute complex 530a is open (with its upper parachute), so as to return the generator 500 to the situation shown in FIG. 5A (with the same operations described-above that are repeated continually).

The generator 500 provides a higher energy yield (since it exploits the wind 105 itself to return the parachute complexes 530a and 530b towards the converter 520, without any waste of the produced energy).

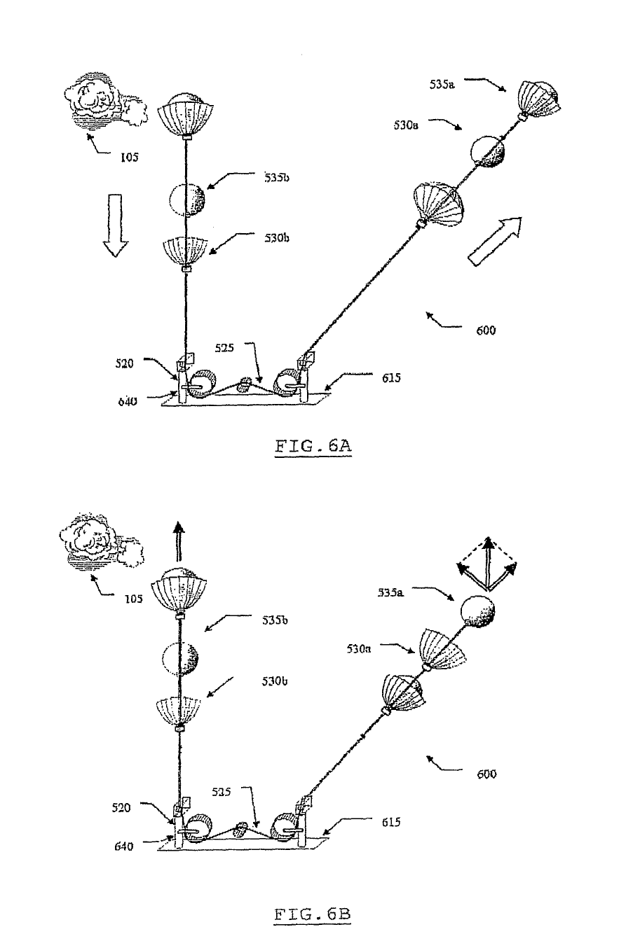

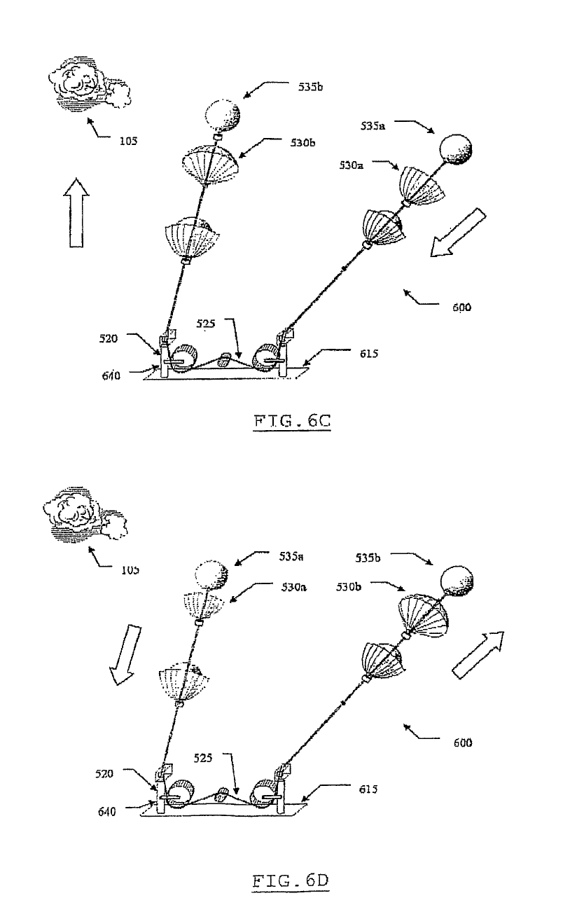

With reference now to FIG. 6A-FIG. 6D, there is illustrated operation of another generator (denoted with the reference 600) according to an embodiment. Particularly, the generator 600 has the same structure as above, with a different base 615 (and a corresponding controller 640); particularly, the base 615 is now installed at the ground 110 so as to be free to rotate around a vertical axis.

Starting from FIG. 6A, when the parachute complex 530b is closed, a terminal portion of the cable 525 associated with it extends substantially in vertical from the converter 520, because of the buoyancy of the balloon complex 535b (being the action of the wind 105 on the balloon complex 535b is assumed to be negligible in this example). Instead, when the parachute 530a is open (with its lower parachute), a terminal portion of the cable 525 associated with it is slanting from the converter 520 in the direction of the wind 105, because of its action on the parachute complex 530a.

Considering now FIG. 68, when the parachute complex 530a reaches the maximum distance it is closed. The parachute complex 530b instead remains closed. Particularly, in an embodiment the parachute complex 530b reaches the converter 520 and it is locked in this position for a while; in this way, it may be possible to perform fast operations on the corresponding section of the generator 600 (for example, to inflate the balloon complex 535b, to recharge batteries being used to supply the relays of the ratchets, and the like).

In this condition (possibly after the unlocking of the parachute complex 530b from the converter 520), the buoyancy of the balloon complex 535b (acting vertically upwards) is completely applied to the cable 525 (arranged in the same direction); conversely, only a component of the (same) buoyancy of the balloon complex 535a (again acting vertically upwards) is applied to the cable 525 (slanting thereto), while a remaining component of the buoyancy of the balloon complex 535a acts perpendicularly to the cable 525 (towards the converter 520). As a consequence, the parachute complex 530b lifts, since the upwards force (due to the buoyancy of the balloon complex 535b) exceeds the downwards force (due to the component along the cable 525 of the buoyancy of the balloon complex 535a); at the same time, the parachute complex 530a lowers approaching the converter 520 (because of the component perpendicular to the cable 525 of the buoyancy of the balloon complex 535a).

As shown in FIG. 6C, the parachute complex 530b is open (with its upper parachute) with a delay from the closing of the parachute complex 530a. For example, this delay is set to a predefined time interval (such as approximately 10-60 s); alternatively, the delay is defined by a predefined offset above the minimum distance (such as approximately 0.2-0.4 times the minimum distance, or approximately 80-160 m). For example, in this condition the parachute complex 530b is at a smaller distance from the converter 520; for example, the distance of the parachute complex 530b is equal to approximately 0.3-0.7, for example equal to approximately 0.4-0.6, such as equal to approximately 0.5 times the distance of the parachute complex 525b (for example, approximately 200-250 m). In this way, it is strongly reduced the risk of any twist between the terminal portions of the cable 525 associated with the two parachute complexes 530a and 530b.

As soon as the parachute complex 530b is open, the action of the wind 105 generates a torque (since it may never be perfectly aligned with the rotation axis of the base 615) that rotates the base 615 by approximately 180° around its vertical axis; consequently, as shown in FIG. 6D, the parachute complex 530b passes downstream and the parachute complex 530a passes upstream the wind 105. In this way, the parachute complex 530b is carried away by the wind 105 (with the corresponding terminal portion of the cable 525 that slants from the converter 520 in the direction of the wind 105); at the same time, the cable 525 pulls the parachute complex 530a towards the converter 520 (with the corresponding terminal portion of the cable 525 that moves towards the vertical from the converter 520). In this way, the parachute complex currently open is always downstream the wind 105, while the other parachute complex being closed is upstream (so as to further reduce the risk of any twist between the corresponding terminal portions of the cable 525).

The same operations are then repeated in a dual manner for the other parachutes of each complex 530a and 530b, until the generator 500 returns to the situation shown in FIG. 6A (with the same operations described above that are repeated continually).

Naturally, in order to satisfy local and specific requirements, a person skilled in the art may apply to the one or more embodiments described above many logical and/or physical modifications and alterations. More specifically, although one or more embodiments have been described with a certain degree of particularity, it should be understood that various omissions, substitutions and changes in the form and details as well as other embodiments are possible. Particularly, an embodiment may even be practiced without the specific details (such as the numerical examples) set forth in the preceding description to provide a more thorough understanding thereof; conversely, well-known features may have been omitted or simplified in order not to obscure the description with unnecessary particulars. Moreover, it is expressly intended that specific elements and/or method steps described in connection with any embodiment of the disclosed solution may be incorporated in any other embodiment as a matter of general design choice.

For example, similar considerations apply if the generator has a different structure or includes equivalent components (either separate to each other or combined together, in whole or in part).

Particularly, an embodiment may also be applied to generate energy from any other fluid flow (for example, steams or tides of water). Likewise, the fluid flow may be converted to any other type of energy (for example, by compressing a gas). Moreover, similar considerations apply if the parachutes have a different shape (for example, of the square type), of if they are replaced with equivalent means based on generic sails (for example, kites, paragliders, wings, drogues); in any case, the parachutes may be switched between similar active and passive conditions (wherein the carrying away by the wind is generically higher in the active condition than in the passive condition—for example, with a Cx=approximately 0.8-1 and a Cx=approximately 0.1-0.3, respectively). The connections cable (between the parachutes and the convert) may be replaced with an equivalent element (for example, a chain). Likewise, it may be possible to return the parachutes in the closed condition towards the converter with other systems (for example, a biasing spring acting on the drum of the converter, or an auxiliary motor that acts on this drum). Naturally, the above-mentioned values of the minimum distance and maximum distance are merely illustrative, and they should not be interpreted in a limitative manner.

Even though in the preceding description reference has been made to a specific mechanism for opening and closing the parachutes, nothing prevents applying a same embodiment to equivalent structures; for example, the sails may slide along the cable externally thereto (only through the collector), or the parachutes may lock to the cable directly (without any additional latch).

A basic implementation of an embodiment without any balloons (or equivalent support elements for the parachutes) is not excluded—for example, in the water.

It may also be possible to provide a single balloon for each pair of parachutes; moreover, the use of dedicated stopping elements (for causing the closing of the parachutes independently of the balloons) may be practicable.

In any case, the balloons may have any shape (for example, spherical or elongated), and more generally they may be replaced with any other element capable of self-moving the parachutes away from the converter (for example, sinkers in the water).

Alternatively, nothing prevents requiring an active command to lock the parachutes in the closed condition and/to along the cable as well.

Naturally, the ratchets may have any other structure (for example, based on racks instead of the gearwheels), or they may be replaced with equivalent structures.

Similar considerations apply if the generator is controlled in a different way (for example, by local controllers installed directly on board of the parachutes).

In an embodiment, the maximum distance and the minimum distance may be detected in another way—for example, by means of altimeters mounted on board of the balloons.

The proposed guide for the connection cable is not strictly necessary, and it may be omitted in a basic implementation of an embodiment.

The generator with two sections as well may have a different structure or include equivalent components (for example, the rotatable base).

Additional or alternatives parameters may be taken into account to trigger the opening of each parachute complex (with a delay from the closing of the other parachute complex); for example, for this purpose it may be possible to measure an altitude of the balloons, a slanting of the connection cable, a force of the wind, and the like. In any case, the above-mentioned values of the delay are merely illustrative, and they should not be interpreted in a limitative manner. In addition, it may also be possible to act on the connection cable (by the converter working as a motor) to facilitate the lifting of the parachute complex to be opened.

Nothing prevents using a stationary base in the generator with the delayed opening of the parachute complexes as well (for example, with the two sections thereof that are arranged transversally to the wind).

Vice-versa, it is noted that the delay of the opening of the parachute complexes, as well as the corresponding additional features (for example, the stop of the parachutes at ground, the rotation of the base, and the like) may be suitable to be used (alone or combined with each other) even without the specific mechanism for opening and closing the parachutes (exploiting the wind) of an embodiment.

Similar considerations apply if the rotation of the parachutes around the connection cable is achieved in a different way (for example, by means of a screw arranged on the collector)—even if this feature is not strictly necessary and it may be omitted in an embodiment.

An embodiment may lend itself to be implemented with an equivalent method (by using similar steps, removing some steps being non-essential, or adding further optional steps); moreover, the steps may be performed in a different order, concurrently or in an interleaved way (at least in part).

In addition, the generator may be controlled by any other device (configured through a corresponding program). In any case, the program may take any form suitable to be used by any data processing system or in connection therewith. Moreover, it may be possible to provide the program on any computer-usable medium; the medium may be any element suitable to contain, store, communicate, propagate, or transfer the program (for example, of the electronic, magnetic, optical, electromagnetic, infrared, or semiconductor type). In any case, an embodiment lends itself to be implemented even with a hardware structure (for example, integrated in a chip of semiconductor material), or with a combination of software and hardware.

From the foregoing it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated.

1. An energy generation system for generating energy from a fluid flow, the system including:
energy conversion means,
sail means switchable between an active condition for being carried away from the energy conversion means by the fluid flow and a passive condition for minimizing said carrying away,
connection means for connecting the sail means to the energy conversion means, the energy conversion means generating said energy when the sail means in the active condition is carried away,
return means for returning the sail means in the passive condition towards the energy conversion means, and
switching means for switching the sail means to the passive condition and to the active condition in response to a maximum distance and to a minimum distance thereof, respectively, from the energy conversion means,
wherein the sail means includes a pair of sail modules slidable along the connection means, each sail module being individually switchable between the active condition and the passive condition, and wherein the switching means includes:
stopping means for each sail module, the stopping means being adapted to stop the sliding of the corresponding sail module in the active condition when carried away thereby causing the switching thereof to the passive condition,
passive locking means for each sail module, the passive locking means being adapted to lock the corresponding stopped sail module in the passive condition,
coupling means for sliding each sail module locked in the passive condition in opposition to the fluid flow to a standing position along the connection means by the other sail module in the active condition when carried away, and
active locking means for each sail module, the active locking means being adapted to lock the corresponding sail module in the standing position thereby causing the switching thereof to the active condition after the unlocking from the passive condition.

2. The system according to claim 1, wherein each sail module includes a sail with an apical hole being slidable along the connection means, a collector being slidable along the connection means, and suspension lines between the sail and the collector, the corresponding passive locking means including means for locking the collector to the apical hole and the corresponding active locking means including means for locking the collector in the standing position.

3. The system according to claim 1, further including support means for self-moving the sail means away from the energy conversion means transversally to the fluid flow.

4. The system according to claim 3, wherein the support means includes a support module being fixed to the connection means for each sail module, the support module defining the corresponding stopping means.

5. The system according to claim 4, wherein the fluid flow is wind, each support module including an aerostatic balloon.

6. The system according to claim 2, wherein each passive locking means includes:
passive self-locking means for self-locking the sail module in the passive condition when the sail module reaches the stopping means, and
passive unlocking means for unlocking the sail module from the passive condition in response to a passive unlocking command,
and wherein each active locking means includes:
active self-locking means for self-locking the sail module in the standing position when the sail module reaches the standing position, and
active unlocking means for unlocking the sail module from the standing position in response to an active unlocking command.

7. The system according to claim 6, wherein each passive locking means and active locking means includes:
a gearwheel being mounted on the sail at the apical hole or on the connection means at the standing position, respectively,
a constraining cable extending between the collector and the gearwheel, the gearwheel being biased to wound the constraining cable around the gearwheel,
a pawl being mounted on the sail at the apical hole or on the connection means at the standing position, respectively, the pawl being biased to engage the gearwheel thereby preventing an unwinding of the constraining cable, and
means for disengaging the pawl from the gearwheel in response to the passive unlocking command or the active unlocking command, respectively.

8. The system according to claim 6, further including control means for causing the repetition alternatively for the pair of sail modules of the steps of:
providing the active unlocking command to one of the sail module being locked in the standing position in response to the maximum distance, and
providing the passive unlocking command to another one of the sail modules being locked in the passive condition and in the standing position in response to the minimum distance.

9. The system according to claim 8, further including detection means for detecting the maximum distance and the minimum distance according to an extension of the connection means from the energy conversion means.

10. The system according to claim 1, wherein the connection means includes a connection cable, the system further including guiding means for guiding the connection cable between the energy conversion means and the sail means, wherein the guiding means includes a first pair of parallel idle rollers and a second pair of parallel idle rollers being arranged transversally to the first pair of idle rollers, the connection cable passing through the first pair of idle rollers and the second pair of idle rollers.

11. The system according to claim 1, further including further sail means being connected to the energy conversion means through the connection means, and further switching means for switching the further sail means to the passive condition and to the active condition in response to the maximum distance and to the minimum distance, respectively, each one of the sail means in the active condition operating alternatively as the return means for another one of sail means in the passive condition.

12. The system according to claim 11, further including means for delaying the switching of each sail means in the passive condition to the active condition with respect to the switching of the other sail means in the active condition to the passive condition.

13. The system according to claim 11, further including a base for installing the energy conversion means at ground, the base being adapted to rotate around a rotation axis perpendicular to the ground.

14. The system according to claim 1, further including means for rotating each sail module around the connection means when the sail module is carried away.

15. A method for generating energy from a fluid flow, the method including the repetition of the steps of:
switching sail means to an active condition for being carried away from a energy conversion means by the fluid flow,
generating said energy by the energy conversion means when the sail means in the active condition is carried away,
switching the sail means to a passive condition for minimizing said carrying away, and
returning the sail means in the passive condition towards the energy conversion means,
wherein the sail means includes a pair of sail modules slidable along connection means for connecting the sail means to the energy conversion means, each sail module being individually switchable between the active condition and the passive condition, and wherein the steps of switching the sail means includes alternatively for the pair of sail modules:
stopping the sliding of one of the sail modules in the active condition when carried away thereby causing the switching thereof to the passive condition,
locking the stopped sail module in the passive condition,
sliding the sail module locked in the passive condition in opposition to the fluid flow to a standing position along the connection means by another one of the sail modules in the active condition when carried away,
locking the sail module in the standing position,
unlocking the sail module from the passive condition thereby causing the switching thereof to the active condition, and
unlocking the sail module from the standing position.

16. A computer program including code means for causing a data processing system to perform the steps of the method according to claim 15 when the computer program is executed on the system.
